(19) United States
(12) Patent Application Publication
(10) Pub. No.: US 2026/0261550 A1
(43) Pub. Date: Sep. 3, 2026

(54) SYSTEMS AND METHODS FOR CORRELATING SSL CERTIFICATE INFORMATION

(71) Applicant: THE PNC FINANCIAL SERVICES GROUP. INC., Pittsburgh, PA (US)

(72) Inventors: Eric Hunsaker, New River, AZ (US); Steven Freeman, Tempe, AZ (US)

(73) Assignee: THE PNC FINANCIAL SERVICES GROUP, INC., Pittsburgh, PA (US)

(21) Appl. No.: 19/324,669

(22) Filed: Sep. 10, 2025

Related U.S. Application Data
(60) Provisional application No. 63/765,401, filed on Feb. 28, 2025.

(51) Int. Cl. H04L 9/40; H04L 43/045

(52) U.S. Cl. CPC H04L 63/0823; H04L 43/045; H04L 63/166

(57) ABSTRACT

Disclosed herein are systems and methods for correlating Secure Sockets Layer (SSL) certificate data. Some disclosed embodiments involve accessing, with an observability platform, SSL data. Some disclosed embodiments involve extracting first certificate data for a certificate. The first certificate data may include a first serial number, host name, and expiration date. Some disclosed embodiments involve obtaining second certificate data for the certificate. The second certificate data may include a second serial number and a common name. Some disclosed embodiments involve normalizing the first serial number and the second serial number to a standard format. Some disclosed embodiments involve generating correlational data by correlating the normalized first serial number with the normalized second serial number. The correlational data may include the host name, the common name, and the expiration date. Some disclosed embodiments involve determining a status of the certificate based on the correlational data.

### CROSS-REFERENCE TO RELATED APPLICATIONS

This disclosure claims priority to U.S. Provisional Application No. 63/765,401, titled “Systems and Methods for Correlating SSL Certificate Information,” filed Feb. 28, 2025, the contents of which are incorporated herein in their entirety.

### TECHNICAL FIELD

The present disclosure relates to systems and methods for improving data transmission related to Secure Socket Layer (SSL) certificates and management of SSL certificates. In particular, the present disclosure relates to enhancing the efficiency and reliability of data transmission processes involving SSL protocols, including issuance, renewal, revocation, and compliance monitoring.

### BACKGROUND

SSL certificates can play a critical role in safeguarding digital communications by encrypting data and verifying server identities. In large organizations, managing thousands of certificates is essential to prevent unauthorized access to a server and ensure uninterrupted secure data exchange. Certificates tied to sensitive operations—such as financial transactions or personal data—require heightened oversight due to their potential impact on security and operations. If certificates expire or become inaccessible, systems may block connections, leading to service outages and exposing data to security threats. Therefore, maintaining visibility and timely renewal of certificates is vital to preserving trust and operational integrity.

Traditional approaches to certificate management often rely on separate systems for registration and monitoring, which can lead to fragmented data and inefficiencies. A registration system may define the purpose and ownership of certificates, while a monitoring system tracks their status and issues alerts. Without integration, these systems may fail to share critical information, resulting in missed renewals, duplicate certificates, and conflicting metadata. This disjointed architecture can waste resources, trigger redundant alerts, and compromise security. Therefore, there is a need for an integrated architecture that centralizes visibility and control over certificates, to help prevent expiration, misconfigured certificates, or duplicate certificates. Such an integrated system may also ensure compliance with internal and external security standards, and enhance security by enforcing protocols associated with the certificates. In addition, streamlining the integrated system may reduce downtime and improve incident response time, thus reducing the use of resources.

### SUMMARY

The systems and methods disclosed herein may be used in various applications and business systems. It is to be understood that the foregoing general description and the following detailed description are exemplary and explanatory only and are not restrictive of the disclosed embodiments.

The disclosed embodiments involve systems and methods for correlating Secure Sockets Layer (SSL) certificate data. Some disclosed embodiments involve accessing, with an observability platform, SSL data. Some disclosed embodiments involve extracting, from the SSL data, first certificate data for a certificate. The first certificate data may include a first serial number, host name, and expiration date. Some disclosed embodiments involve obtaining second certificate data for the certificate from a machine identity management platform. The second certificate data may include a second serial number and a common name. Some disclosed embodiments involve normalizing the first serial number and the second serial number to a standard format. Some disclosed embodiments involve generating correlational data by correlating the normalized first serial number with the normalized second serial number. The correlational data may include the host name, the common name, and the expiration date. Some disclosed embodiments involve determining a status of the certificate based on the correlational data.

According to a disclosed embodiment, the SSL data establishes a secure connection over an SSL port.

According to a disclosed embodiment, determining the status of the certificate includes determining if the certificate is expired or redundant.

According to a disclosed embodiment, the operations may further include, based on the determination that the certificate is expired, generating and transmitting a certificate renewal request to the machine identity management platform.

According to a disclosed embodiment, the operations may include displaying the status on a user interface.

According to a disclosed embodiment, correlating the normalized first and second serial numbers includes performing one or more relational operations.

According to a disclosed embodiment, the operations may include accessing the observability platform via a first application programming interface (API) and accessing the machine identity management platform via a second API.

Other systems, methods, and computer-readable media are also discussed herein. Disclosed embodiments may include any of the above aspects alone or in combination with one or more aspects, whether implemented as a method, by at least one processor, and/or stored as executable instructions on non-transitory computer readable media.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 presents an illustration of a system for viewing secure connection data, consistent with embodiments of the present disclosure.

FIG. 2 is an illustration of a system for viewing certificate data, consistent with embodiments of the present disclosure.

FIG. 3 is an illustration of a system for correlating data, consistent with disclosed embodiments.

FIG. 4 illustrates a block diagram of a system for correlating SSL data, consistent with embodiments of the present disclosure.

FIG. 5 illustrates a block diagram of a correlator engine, consistent with embodiments of the present disclosure.

FIG. 6 illustrates a block diagram of an environment for generating correlational data, consistent with embodiments of the present disclosure.

FIG. 7 illustrates a block diagram of a system 700 for resolving certificate data vulnerabilities, consistent with embodiments of the present disclosure

FIG. 8 illustrates a flow chart of a process for correlating certificate data, consistent with embodiments of the present disclosure.

FIG. 9 illustrates a diagram of an operating environment, consistent with embodiments of the present disclosure.

### DETAILED DESCRIPTION

Reference will now be made in detail to exemplary embodiments, discussed with reference to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, steps may be added or steps may be removed without departing from the envisioned embodiments. Thus, the materials, methods, and examples are illustrative only and are not intended to be necessarily limited.

Secure Sockets Layer (SSL) certificates may be used to encrypt and secure data transmissions between users and websites. SSL certificates authenticate a server's identity to establish trust and ensure that data, including sensitive data such as passwords, financial details, or personal information, cannot be intercepted or altered during transmission. Disruptions to the operation of certificates may result in unencrypted or unsecure communications, resulting in possible data theft, eavesdropping of confidential data, or data exploits. Typically, computing systems and networks for a single organization may involve tens of thousands of certificates that serve to mitigate data transmission disruptions and protect data transmitted through the computing system or network. Tracking the large volume of certificates associated with an organization is a technical challenge, as expiration of a certificate can result in unsecured transmissions. Due to this volume, some certificates protecting higher-sensitivity information may have a higher priority or impact than other certificates. For example, certificates dealing with payment platforms or personally identifiable information may have higher impact, and thus, may need more robust monitoring and registration. In addition, when a system's certificate is not visible, browsers, Application Programming Interfaces (APIs), or client applications attempting to access data from the system (or transmit data to the system) may prevent a connection from being established with the system due to the lack of security. Accordingly, proper maintenance of certificates is important to mitigate service disruptions and protect data.

Conventional methods and systems of registering or tracking SSL certificates may involve communicating between disparate systems, which may result in data from one system not being able to access data from the other system, and vice versa. Such disparate systems may also result in a duplication of data. For example, a first system may have data for a certificate, and a second system may have data for the same certificate, and conventional systems and methods may fail to provide the ability to compare, resolve, or correlate the data between the two systems. As such, conventional systems and methods may result in certificates expiring or lapsing, which can disrupt secure communication and cause services outages, cybersecurity risks, and compliance issues.

For example, a first system may provide registration for certificate data, such as what certificates should exist and their purpose (e.g., what the certificate data is ensuring secure communication for). The first system may be a registration system have access to the owner and application of the certificate data. A second system may provide monitoring for certificate data, such as tracking whether certificates are active or expired. The second system may be a monitoring system providing alerts for the certificates it has knowledge of. In conventional or traditional computing systems, the systems that provide registration are typically different than the systems that provide monitoring. Accordingly, the systems that provide registration do not have access to the information contained by the systems that provide monitoring, and vice versa. As a result, certificates may come to expire without being renewed, resulting in unsecured data transmissions. In addition, conventional or traditional systems, create redundancies and duplicate certificates when monitoring systems fail to recognize registered certificates or registration systems fail to recognize monitored certificates. For example, conventional systems may store duplicate records (e.g., in memory) for the same certificate across different platforms with no ability to resolve the duplicity, or (due to lack of synchronization) one platform may issue a new certificate for a communication protocol while the other platform already has an existing certificate for the protocol. This may result in unnecessary consumption of storage resources, inefficiencies or errors caused by metadata conflicts between duplicate certificates, redundant alerts transmitted over the system, as well as redundant renewals of certificates. Embodiments of the present disclosure may enable correlation of certificate data between systems, thereby enriching certificate data, allowing the discovery of unregistered certificates, and providing a more robust monitoring solution to mitigate certificate expiration. The disclosed embodiments involve normalization of certificate data, which can improve cross-system interoperability for analyzing certificate data. The disclosed embodiments provide enhanced visibility of certificates, which can ensure timely renewal, and effective management of these security assets, which mitigates risks associated with lapsed or misconfigured certificates, such as data breaches, service outages, and compliance failures. When organizations can readily track certificate status, including expiration dates, common names, host names, and serial numbers across disparate platforms, they mitigate risks associated with lapsed or misconfigured certificates—such as data breaches, service outages, and compliance failures. In addition, the disclosed embodiments provide enhanced awareness for identifying which certificates are tracked, ensuring that the proper resources are dedicated to high-impact certificates.

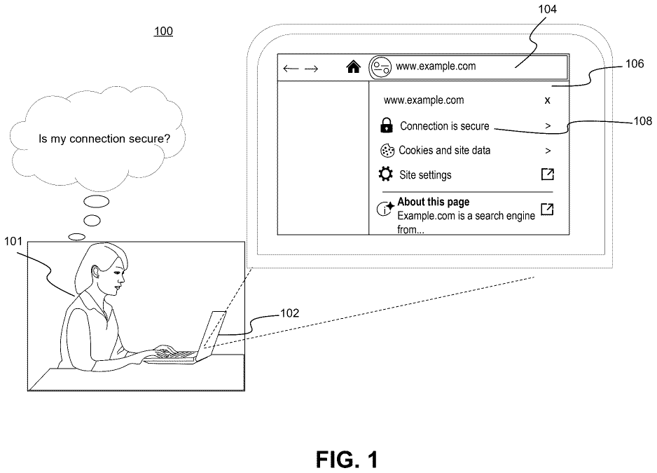

FIG. 1 illustrates a system 100 for viewing secure connection data, consistent with embodiments of the present disclosure. In system 100, a user 101 may access a computing device 102. User 101 may be an individual that interacts with computing environments that require secure data transmission, such as a technology administrator, security engineer, system developer, compliance analyst, or an end-user. As an example, computing device 102 can include a computer, laptop, cellular device, tablet, or the like. Computing device 102 may be connected to a website 104 (e.g., via a networked server or over an internet connection), and website 104 may display secure connection information 106. Secure connection information 106 may include information describing the connection between computing device 102 and website 104, including SSL data and secure indication 108. For example, secure indication 108 may be an icon indicating (e.g., to user 101 on a user interface of computing device 102) that the connection between computing device 102 and website 104 is secure. In some embodiments, a secure connection may involve a connection between two systems (e.g., parties) in which data being transmitted between the systems is protected from unauthorized access or tampering. For example, a secure connection between computing device 102 and website 104 may include encryption (e.g., privacy protections to prevent unauthorized party access from a third party), authentication (e.g., verifying the identity of one or both parties and ensuring that communication is reaching the intended party), and integrity checking (e.g., ensuring data is not improperly altered in transit).

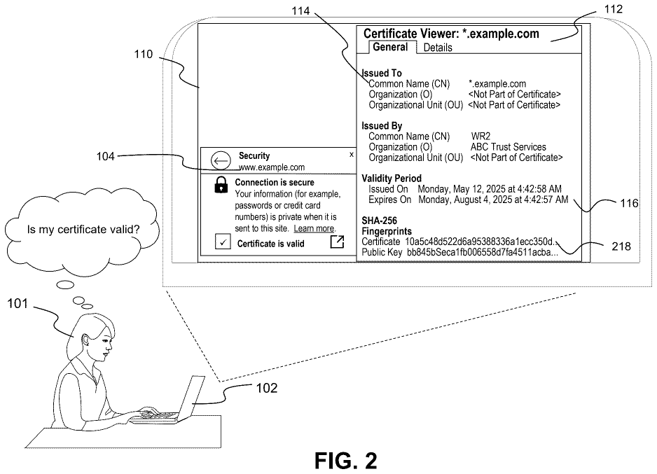

FIG. 2 is an illustration of a system for viewing certificate data, consistent with embodiments of the present disclosure. For example, computing device 102 (as described with respect to FIG. 1) may display SSL information 110. SSL information 110 may include a website name corresponding to website 104, such as www. example. com, and certificate data 112. Certificate data 112 may include data for authenticating the identity of a server and enabling encryption between computing device 102 and website 104. For example, certificate data 112 may include data presented or available during a secure connection handshake between computing device 102 and a server for www.example.com. In some embodiments, certificate data 112 may include a common name 114, host name, and expiration data 116. For example, a common name may include the domain name or entity the certificate is for (e.g., fully qualified domain name), such as www.example.com or “*.example.com.” The common name may refer to the primary domain in the SSL data's subject field and may indicate which site is secured by the certificate corresponding to certificate data 112. In some embodiments, a common name may also include a subject alternative name (SAN), which may be a list of valid names in the certificate. Expiration data 116 may include a validity period for the certificate. For example, certificate data 112 may include the expiration date of the certificate as well as an issue date of the certificate. In some embodiments, certificate data 112 may include issuer information that describes the organization issuing the certificate. A host name may include the exact domain or subdomain a browser connects to when accessing a website. Hosts names may include a label assigned to a device within a network, such as “serverx” in “serverx.example.com”. A website 106 may provide certificate data 112 to indicate (e.g., to user 101) that the certificate is valid. For example, website 104 may provide an icon indication to visually display that the certificate is valid and the connection is secure, as well as providing expiration information 116. As an example, a browser may identify a host name in a URL for a website, verify that the host name matches a common name, and then establish a secure connection. If the host name does not match a common name, the browser may provide a mismatch error and deny access or connection between website 104 and computing device 102. In some embodiments, certificate data 112 may include a serial number 218. Serial number 218 may be a unique identifier for the certificate. Serial number 218 may assist in differentiating different certificates, identifying active certificates, and identifying revoked certificates. For example, serial number 218 may comply with Certificate Revocation Lists (CRLs) or Online Certificate Status Protocol (OCSP) responses. Serial number 218 may include a variety of formats, including hexadecimal, integer, alpha-numeric, base64, or the like. Serial number 218 may be issued by a Certificate Authority issuing the certificate. In some embodiments, serial number 218 may change upon renewal of a certificate. In some embodiments, serial number 218 may be associated with a fingerprint. A fingerprint may include a cryptographic hash value generated by applying a hashing algorithm (such as SHA-256, SHA-1, or MD5) to certificate data 112. The hash value may include a fixed-length string of characters produced by applying a function (e.g., a hashing algorithm), to an input of arbitrary size (such as a digital certificate). The hashing algorithm may process the input data and generate a unique identifier that represents the original content. A fingerprint may be derived from the certificate data 112, and therefore may change when a part of the certificate changes. Thus, hashing may enable fingerprints to be highly reliable for confirming the integrity and authenticity of a certificate. As an example, fingerprints may be represented as a fixed-length hexadecimal string and may be unique to a specific certificate instance.

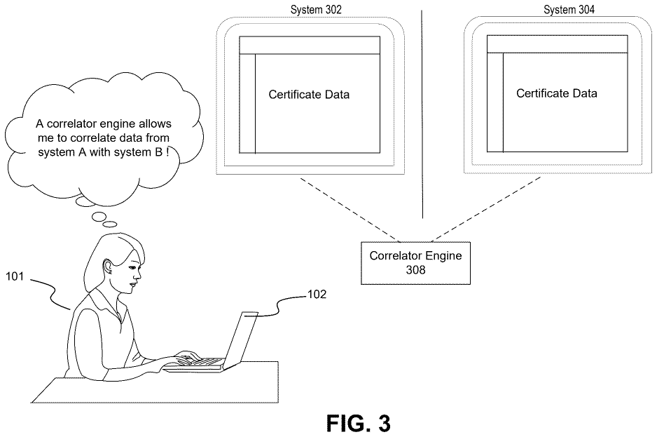

FIG. 3 illustrates a diagram of correlating secure connection data, consistent with embodiments of the present disclosure. As described herein, systems for registering or tracking SSL certificates may involve communicating between disparate systems, which may result in data from one system not being able to access data from the other system, and vice versa. For example, a first system 302 may be responsible for renewing certificates for website 104, while a second system 304, which is different from first system 302, may be responsible for tracking certificate expiration date. Since they are separate systems, first system 302 and second system 304 may not have mutual communication with one another. As such, transmission of information between the systems may be limited, which may cause certificates to lapse or expire, resulting in unsecured connections between computing device 102 and website 104 (as described with respect to FIGS. 1 and 2) or errors that prevent connections between computing device 102 and website 104. The disclosed embodiments may include a correlator engine 308, which may enable data transmissions between system 302 and system 304. Correlator engine 308 may be a specialized component configured to unify and analyze SSL certificate data across disparate platforms. Correlator engine 308 may allow synchronization and communication between system 302 and system 304, which can assist in enhancing awareness and visibility of certificates that can be monitored, registered, or monitored and registered. In addition, correlator engine 308 may ingest certificate data from various systems, by for example, API calls, and standardize the ingested data into a consistent format for use across systems. Such standardization may ensure reliable comparison and use across systems. In some embodiments, predefined rules may be used to infer missing values in the data or correct anomalies within the data. In some embodiments, correlator engine 308 may be used to normalize certificate data by generating correlational data, consistent with disclosed embodiments. Correlator engine 308 may also be used to determine a status of a certificate and report its findings to a display interface, consistent with disclosed embodiments. Correlator engine 308 may work in conjunction with the other hardware elements described herein.

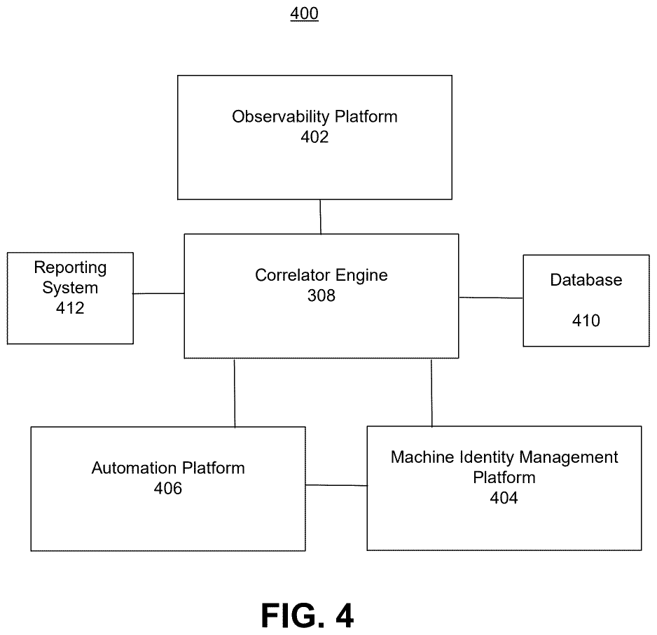

FIG. 4 illustrates a system 400 for correlating certificate data, consistent with embodiments of the present disclosure. System 400 may include various systems having certificate data, such as observability platform 402. Observability platform 402 may provide monitoring for SSL certificates. Observability platform 402 may be an example of a monitoring system or monitoring platform. Observability platform 402 may be a system, application, module, or the like, that may detect or monitor the validity of SSL certificates and provide alerts (e.g., to a user interface or reporting system), such as when a certificate has expired or is approaching expiration. For example, observability platform 402 may include Dynatrace. Observability platform 402 may search for SSL ports and run an SSH command to obtain certificate data that may establish a secure connection for the SSL ports. SSL communications may operate over a designated port, such as a port for HTTPS traffic, to distinguish secure communications from non-secure ones (e.g., HTTP over a port). When a client initiates a connection to an SSL-enabled port, the server may respond by presenting the digital certificate to authenticate the server's identity to establish an encrypted session key, ensuring confidentiality and integrity of the transmitted data. The SSL data may be presented to the port as part of a connection handshake and may be used to authenticate the connection. Observability platform 402 may include certificate data such as common name, host name, and expiration date.

System 400 may include machine identity management platform 404. Machine identity management platform 404 may register and track SSL certificates. Machine identity management platform 404 may be an example of a monitoring platform or monitoring system. For example, machine identity management platform 404 may include Venafi or a combination of Venafi and Difenda. Machine identity management platform 404 may include the common name and expiration date of certificates. In some embodiments, system 400 may include correlator engine 308. Correlator engine 308 may enable communication and facilitate data transmission between observability platform 402 and machine identity management platform 404. Correlator engine 308 may generate correlational data (as described below), such as by correlating data between observability platform 402 and machine identity management platform 404 by matching certificate data in them. Correlator engine 308 may include rules-based logic and may be configured to perform analysis and/or prediction of data, such as clustering, classifying, or categorizing of certificate information. Rules-based logic may include analyzing data or performing decisions, classifications, or predictions based on pre-defined rules, such as clustering, classification, or categorization based on conditional statements. For example, based on common name, correlator engine 308 may correlate information that is available in observability platform 402 with information available in machine identity management platform 404, and vice versa, enabling improved communication in system 400, as well as providing data that may not be available in one platform to the other platform. As such, system 400 may provide alerting and tracing for certificates approaching expiration.

In some embodiments, correlator engine 308 may store correlated data in database 410. For example, correlator engine 308 may provide correlated data in a report, such as a spreadsheet, text file, PDF, CSV, document, or the like, which can be stored in database 410. A database may be a collection of data stored electronically and managed by a database management system for data retrieval and/or manipulation. Additionally, or alternatively, correlated data may be stored directly in database 410. For example, database 410 may be a SQL database that can be queried. In some embodiments, system 400 may include automation platform 406. Automation platform 406 may automate processes for certificates, such as tracking expiration alerts or automating issuance or renewal of certificates. In some embodiments, system 400 may include reporting system 412. For example, based on a determination from correlator engine 308 that a certificate may be approaching expiration, reporting system 412 may provide a notification (e.g., to a user interface and/or to system 400).

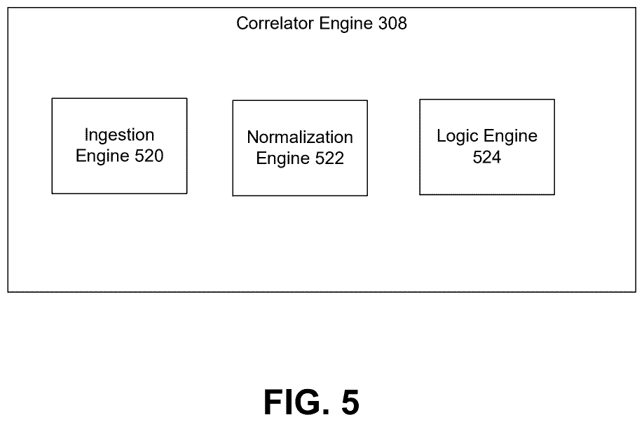

FIG. 5 illustrates a block diagram of correlator engine 308, consistent with embodiments of the present disclosure. In some embodiments, correlator engine 308 includes an ingestion engine 520, normalization engine 522, and a logic engine 524. Ingestion engine 520 may assist in obtaining certificate data.

Ingestion engine 520 may be configured to extract certificate data from SSL data, such as obtaining serial numbers, host names, expiration dates, common names, or metadata, from SSL data. Ingestion engine 520 may obtain data via API calls from various systems. For example, ingestion engine 520 may perform API calls to observability platform 402, automation platform 406, or machine identity management platform 404, to obtain data including serial numbers, common names, host identifiers, port numbers, install locations, validity periods, expiration dates, monitoring status, or the like. In some embodiments, ingestion engine 520 may automatically extract data, such as based on a schedule (e.g., periodically) or based on a response to an event (e.g., upon detection of creation or modification of a certificate). Additionally, or alternatively, ingestion engine 520 may include rules-based configurations that allow the definition of which fields to extract, how frequently to poll each system, or how to handle errors or incomplete responses. As an example, ingestion engine 520 may be configured as a script, microservice architecture, plugin, containerized environment (e.g., Docker), extension, or the like. Ingestion engine 520 may provide the extracted data to correlator engine 308. Ingestion engine 520 may provide outputted data in a variety of formats, including JSON, XML, CSV, relational tables, or spreadsheets, as non-limiting examples. It will be appreciated that ingestion engine 520 may provide automation and scalability to analyze and extract data from large quantities of certificates, which can be a computationally-complex process.

Correlator engine 308 may receive extracted certificate date (e.g., from ingestion engine 520) from different source systems (e.g., observability platform 402, automation platform 406, machine identity management platform 404) that may exist in different formats due to the different source systems being disparate from one another. Data from one platform may be extracted and outputted as a different file format than certificate data from other platforms. For example, data from observability platform 402 may be extracted in a JSON while data from machine identity management platform 404 may be extracted in a CSV format. In addition, data from different platforms can include different value, format, or semantic representations. For example, data may vary in date formatting (e.g., month-date-year vs date-month-year), capitalization or spelling, field name (such as synonymous fields may be referred to differently, like certificate_id vs cert_id, hostname vs host, or serial_number vs serial), Boolean or status (e.g., true or false vs yes or no), or numeric format (e.g., port numbers or certificate numbers can be provided as hashes, integers, or floats). In one example of serial number formatting, some systems may format serial numbers as a series of a series of two-digit hexadecimal values separated by colons (e.g., 0b:5d:61:1c:70:c9:9b:a1:50:63:1c:5a:35:da:5b:86:b1:11:6c:ba) while other systems format serial numbers as a single, long alphanumeric or hexadecimal string (e.g., 27c092c344a6c2000000000000). It will be recognized that discrepancies in formatting as described herein can prevent reliable comparison, correlation, and analysis of certificate data. Fields being represented inconsistently may reduce accuracy in correlating data, such as when correlator engine 308 may fail to recognize that two records refer to the same certificate due to inconsistencies in formatting between data. These discrepancies may lead to false positives in correlation (e.g., a determination that a match for records between systems exists when the match does not exist) or false negatives, which may lead to missed alerts for expiring certificates or duplicate data that is unaccounted for.

Normalization engine 522 may provide transformation and standardization for raw certificate data into a consistent, structured format. Normalization engine 522 may assist in minimizing formatting differences between certificate data so that certificate data from different systems can be reliably compared. Normalization engine 522 may align or standardize certificate data, such as through mapping data to a consistent format (e.g., mapping cert_id and certificate_id both to the field of “certificate ID”) or transforming data to a consistent format (e.g., converting dates to a standard format of month-date-year or converting the formatting of serial numbers to hexadecimal). Normalization engine 522 may be implemented, for example, as a script, plugin, microservice, or container. Additionally, or alternatively, normalization engine 522 may include one or more machine learning models. A machine learning model may receive raw certificate records as input and then output a normalized version of the record that conforms to a predefined schema. For example, the machine learning model may learn to recognize that “cert_id,” “certificate_id,” and “serial_number” all refer to the same concept, and map them to a common denomination. A machine learning model may also infer missing values (e.g., hostnames or install locations) based on patterns learned from historical data, or detect and correct malformed fingerprints using anomaly detection techniques. The machine learning model may be trained on labeled datasets containing examples of correctly normalized records, and continuously improved through feedback loops from downstream validation engines. In some embodiments, the machine learning models may be updated on an iterative basis. As an example, normalization engine 522 may include large language models (LLMs) or normalization engine 522 may be configured to communicate with a large language model via an API endpoint. It will be appreciated that by providing normalization of certificate data into standardized formats, normalization engine 522 may assist in enhancing interoperability between different platforms containing certificate data. In addition, normalization of data may help improve matches for certificate data originating from the different platforms and reduce mismatches due to formatting differences, which enables improved correlation for determining certificates that may be unregistered or unmonitored. It will be appreciated that improving correlation, and thereby enhancing awareness of unregistered or unmonitored certificates, may mitigate security vulnerabilities for internet-based communications by reducing the occurrence of certificate expiration due to certificates being unregistered or unmonitored.

Logic engine 524 may assist with analysis and computation for correlator engine 308. Logic engine 524 may correlate certificate data from various systems, such as correlating data from observability platform 402 with machine identity management platform 404. Correlating certificate data may involve unifying or matching certificate data from different systems. Correlating certificate data may include comparing certificate data from one system with certificate data from one or more different systems to determine matches between the certificate data. The systems may include platforms, services/microservices, applications, plugins, scripts, or the like. For example, logic engine 524 may compare normalized certificate data from observability platform 402 with normalized certificate data from machine identity management platform 404 and determine if certificate data from observability platform 402 matches any certificate data from machine identity management platform 404, and vice versa. In some embodiments, logic engine 524 may include relational data operations. Logic engine 524 may involve using relational operations to query certificate data for determining the presence of matches. For example, logic engine 524 may include Structured Query Language (SQL) operations to analyze correlations in certificate data. In some embodiments, correlating certificate data may involve applying machine learning models to the certificate data. For example, logic engine 524 may include one or more machine learning models configured to identify whether certificate data from different systems represents the same certificate. The machine learning models may be trained on examples of matched and unmatched pairs of certificate data from differing systems. Exemplary models may include clustering models, classification models (e.g., random forest, logistic regression), or language models that may learn to associate certificates based on similarities in certificate data. As described herein, exemplary implementations of logic engine 524 may include deployments as a script, microservice, plugin, application, or containerized environment.

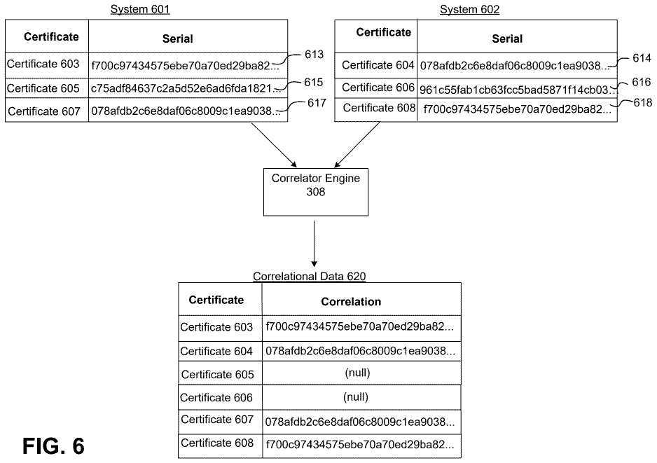

FIG. 6 illustrates a block diagram of an environment for generating correlational data, consistent with embodiments of the present disclosure. As described herein, a computing system may involve monitoring systems and registration systems. For example, system 601 may be a registration system, and may include machine identity management platform 404; system 602 may be a monitoring system, and may include observability platform 402. It is to be understood that these are merely exemplary and different types of systems and formats of systems may be used.

System 601 and system 602 may each include certificate data for a plurality of certificates, as described herein. System 601 may include serial numbers 613, 615, and 617 corresponding respectively to certificate data of certificates 603, 605, and 607. System 602 may include serial numbers 614, 616, and 618 corresponding respectively to certificate data of certificates 604, 606, and 608. It will be appreciated that the exemplary quantities of certificate data displayed in FIG. 6 are for convenience of description and illustration, and certificate data typically involves at least thousands of certificates, as described herein. In some embodiments, the serial numbers 613-618 may be ingested and normalized by correlator engine 308. Correlator engine 308 may generate correlational data 620 based on serial numbers 613-618 and certificate data 603-608. Correlational data 620 may include data that describes or defines correlations between certificate data of systems 601 and 602. Correlational data 620 may include organized information created by matching certificate records from different systems that refer to the same certificate. Correlational data 620 may include a certificate's identification and whether the certificate has a match across different systems. For example, correlational data 620 may include certificates 603-608, and include an indication of whether each certificate exists in system 601 and system 602. Based on the determination of a match, such as for certificates 603, 604, 607, and 608, correlational data 620 may include indications such as the serial number itself, Boolean values (e.g., true, 1, yes), or the like. Based on the determination that a match does not exist, such as for certificates 605 and 606, correlational data 620 may include indications that of a lack of a match, such as “null,” Boolean values (e.g., false, 0, no), or the like.

Logic engine 524 may assist in generating correlational data 620. Generating correlational data 620 may involve determining the presence of shared certificate data between systems 601 and 602, which indicates that a certificate can either be registered but not monitored (e.g., existing on system 601 but not on system 602), monitored but not registered (e.g., existing on system 602 but not system 601), or registered and monitored (e.g., existing on system 601 and system 602). In some embodiments, generating correlational data 620 may involve performing relational operations on the certificate data obtained from system 601 and system 602. For example, the relational operations may involve relational joins. Join operations, such as SQL joins, allow the combination of rows from two or more tables or tabular-formatted data based on a related column between them. Joins establish a relationship between data using a “join condition,” which specifies the columns from data tables that should be compared. A join may merge data from multiple tables into a single result set. For example, based on matching values of serial numbers for certificate data, join operations may return the certificate identifications corresponding to the matched serial numbers. In some embodiments, join operations may involve inner joins (e.g., returning rows with matching values in both tables), left joins (returns all rows from the left or first table, and matched rows from the right or second table), right joins (returns all rows from the right or second table, and matched rows from the left or first table), and full joins (returns all rows when there is a match in either table). For example, a left join may be used to determine, with system 601 being the left table and system 602 being the right table, which certificates are registered but not monitored by analyzing all certificates that are registered to determine which ones are not monitored (e.g., the lack of a matching serial number would indicate that a certificate is registered and not monitored). In another example, a right join may be used to determine which certificates are monitored but not registered by analyzing all certificates that are monitored to determine which ones are not registered. Thus, it will be appreciated that generating correlational data 620 can enhance visibility and awareness of certificates that are not registered or not monitored, which provides enhanced insights into possible security vulnerabilities.

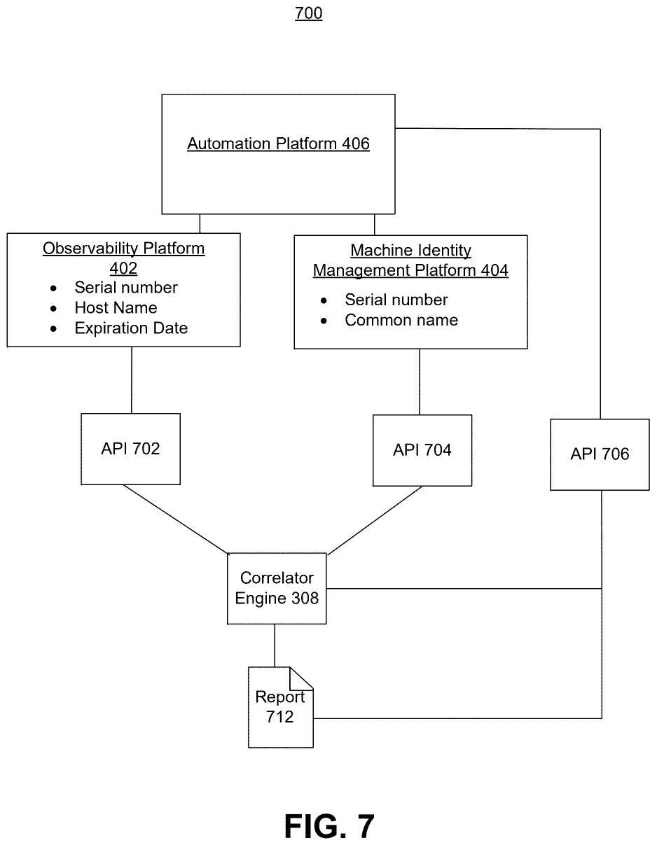

FIG. 7 illustrates a block diagram of a system 700 for resolving certificate data vulnerabilities, consistent with embodiments of the present disclosure. As described herein, correlator engine 308 may obtain certificate data from observability platform 402 and machine identity management platform 404. In some embodiments, correlator engine 308 may retrieve information from observability platform 402 and machine identity management platform 404 via APIs. For example, correlator engine 308 may query observability platform 402 via API 702 or query machine identity management platform 404 via API 704. As described herein, in addition to serial numbers, certificate data may include information such as common names, host names, and expiration dates for a certificate. A monitoring system, such as observability platform 402, may include a certificate's host name and expiration date, and a registration system, such as machine identity management platform 404, may have the common name for the certificate. Correlator engine 308 may generate correlational data such that certificates shared by both observability platform 402 and machine identity management platform 404, or included in one platform and not the other, can be identified. In some embodiments, the correlation data may include serial numbers for certificates, as well as the host name, expiration date, and common name for a certificate. For example, if a match exists between a serial number for a certificate from observability platform 402 and a serial number for a certificate from machine identity management platform 404, correlator engine 308 may determine that the certificate is shared or common between them (e.g., referring to the same certificate) and generate correlational data including the serial number as well as the host name, expiration date, and common name. Thus, correlational data may allow for linkage and unification of previously partitioned data, as host name and expiration date may be associated with the common name for the same certificate rather than being a part of disparate systems. It will be appreciated that this unification may allow for increased visibility and enhanced monitoring of certificates, which may help to mitigate certificate expiration and the presence of redundant certificates that can consume a computing environment's resources. For example, redundant certificates may consume memory of a computing device or database, and reducing redundant or duplicate certificates may conserve such memory. In some embodiments, system 700 may generate a report 712 that includes the correlation data. As an example, report 712 may include a spreadsheet, text file, PDF, CSV, document, or the like. Report 712 may provide a convenient overview of the status of certificates, such as any certificates that may be monitored but not registered or registered but not monitored. Report 712 may also provide an overview of certificates that may be approaching expiry, or certificates that may be duplicated. In some embodiments, report 712 may be provided to reporting system 412. For example, report 712 may be provided to a user interface for display. In some embodiments, the user interface may be updated iteratively based on the generation of an updated version of report 712. In some embodiments, the user interface may allow certificate data to be filtered or sorted based on a certificate's impact on communication security, a certificate's expiration date, registration status, monitoring status, or the like.

In some embodiments, correlational data 620 may be used to trigger automations for system 700. For example, correlator engine 308 and/or report 712 may communicate with automation platform 406 via API 706. Correlational data 620 may cause automation platform 406 to perform processes that provide services for observability platform 402 or machine identity platform 404. For example, if correlational data 620 includes an indication that a certificate is not monitored, automation platform 406 may instruct observability platform 402 to begin tracking the certificate (e.g., automatically begin tracking of the certificate or opening a ticket that will be reviewed for beginning tracking). In another example, if correlational data 620 includes an indication that a certificate is not registered, automation platform 406 may instruct machine identity management platform 404 to register the certificate (e.g., automatically register the certificate or opening a ticket for registration to be reviewed). Additionally, or alternatively, if correlational data 620 includes an indication that certificate may be approaching expiry, automation platform 406 may issue a renewal request for the certificate. For example, if the certificate is to expire within a threshold period (e.g., less than a month, week, day, or other time period before expiry), the renewal request may be issued.

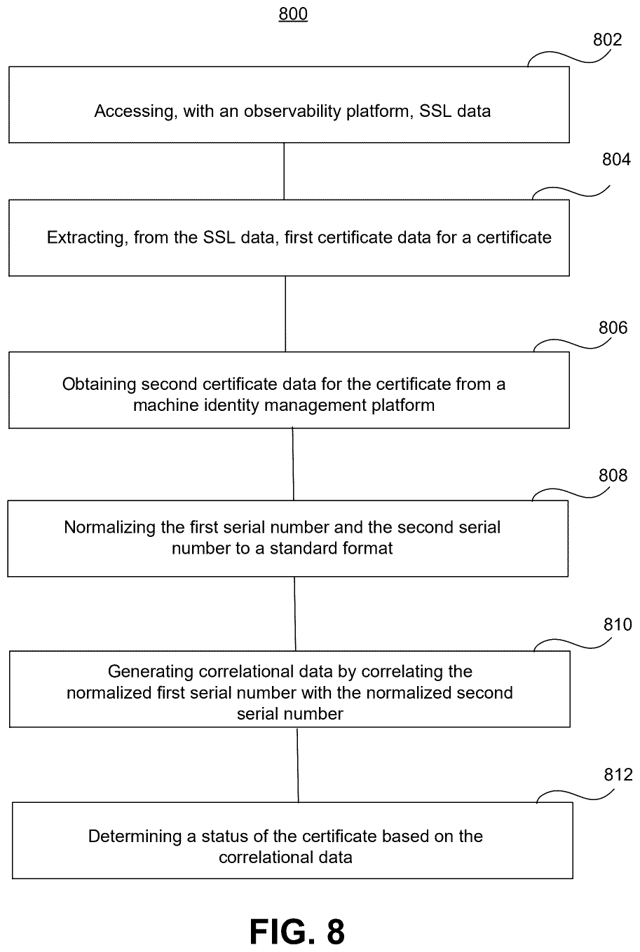

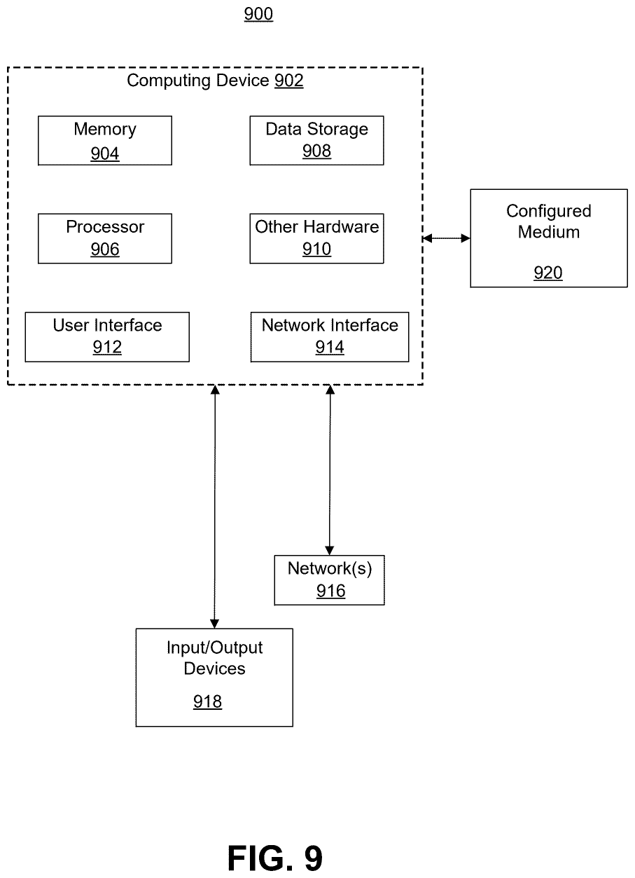

FIG. 8 displays a process 800 for correlating SSL data, consistent with embodiments of the present disclosure. In some embodiments, process 800 may be executed by computing device 902 (described below with respect to FIG. 9), by a processor of computing device 902, by correlator engine 308, by system 400, or by another system/device. In some embodiments, process 800 includes a step 802 of accessing, with an observability platform, SSL data. Step 802 may involve accessing SSL data via observability platform 402. For example, observability platform 402 may store SSL data for establishing a secure connection with an SSL port.

In some embodiments, process 800 includes a step 804 of extracting, from the SSL data, first certificate data for a certificate. The first certificate data may be extracted from the certificate based on certificate data from observability platform 402, consistent with disclosed embodiments. For example, correlator engine 308 may access and ingest the certificate data from observability platform 402. In some embodiments, the observability platform may be accessed via an API. For example, an API may facilitate transmission of certificate data between observability platform 402 and correlator engine 308 by enabling interactions through which correlator engine 308 may obtain certificate data. In some embodiments, the first certificate data may include a first serial number, host name, and expiration date for the certificate.

In some embodiments, process 800 includes a step 806 of obtaining second certificate data for the certificate from a machine identity management platform. The second certificate data may be extracted from data of machine identity management platform 404. For example, ingestion engine 520 of correlator engine 308 may access and ingest the certificate data from machine identity management platform 404. In some embodiments, the machine identity management platform may be accessed via an API. For example, an API may facilitate transmission of certificate data between machine identity management platform 404 and correlator engine 308 by providing endpoints for accessing certificate data. In some embodiments, the second certificate data can include a second serial number and a common name. If the second certificate data and the first certificate data both originate from the same certificate, the first serial number may be the same as the second serial number.

In some embodiments, process 800 includes a step 808 of normalizing the first serial number and the second serial number to a standard format. As described herein, normalizing serial numbers may involve processing, transforming, or projecting data to a consistent or uniform format. For example, normalization engine 522 of correlator engine 308 may facilitate normalizing serial numbers obtained in steps 804 and 806. Serial numbers may be normalized to a pre-determined format, or a format of a second serial number can be normalized to match that of a first serial number. For example, serial numbers may be normalized into a canonical format that adheres to a predefined schema, such as converting all values to lowercase hexadecimal or alphanumeric strings without leading zeros or extraneous characters. The normalization may also involve decoding encoded values or stripping formatting artifacts to ensure compliance with a given standard. It will be appreciated that, by normalizing serial numbers to a standard format, the serial numbers may be in a more useful format for analyzing correlations between serial numbers.

In some embodiments, process 800 includes a step 810 of generating correlational data by correlating the normalized first serial number with the normalized second serial number. Generating correlational data 620 may involve correlating the serial numbers (e.g., of step 808) to determine the presence of a match between the first serial number corresponding to the first certificate and the second serial number corresponding to the second certificate. For example, a correlation match may include an exact correspondence (e.g., the first normalized serial number being exactly the same as the second normalized serial number) or a similar match (e.g., the first serial number matching 95% with the second serial number). In some embodiments, correlating serial numbers may involve relational operations between the first certificate data and the second certificate data. For example, step 808 may involve performing SQL joins, such as a left or right join, to compare first certificate data and second certificate data and determine the presence of a shared serial number between the first certificate data and the second certificate data. In step 808, if the serial numbers are determined to match (e.g., a shared serial number exists), correlational data 620 may indicate the presence of such match (e.g., through confirming the serial number, displaying a Boolean value of True, or the like). Step 808 may involve generating correlational data 620 that includes the identity of the certificate, the serial number, the host name, common name, and expiration date of the certificate. Alternatively, if in step 808 there is no match between the first serial number and the second serial number, correlational data 620 may indicate the lack of a match. For example, correlational data 620 may indicate that a serial number (and thus awareness of a certificate) exists on one of observability platform 402 or machine identity management platform 404, but does not exist on the other of observability platform 402 or machine identity management platform 404. It will be appreciated that generating correlational data may enable synchronization and communication between observability platform and machine identity management platform, which may mitigate occurrences of one platform generating a certificate that already exists, but it is unaware of, thereby reducing duplicate or redundant certificate data.

In some embodiments, process 800 includes a step 812 of determining a status of a certificate based on correlational data. For example, if the correlational data generated in step 810 indicates that the first serial number and the second serial number match, step 812 may involve determining that the first certificate data and the second certificate data refer to the same certificate. Thus, the status of the certificate may be that the certificate is both monitored and registered. Alternatively, if the correlational data indicates that either the first serial number or the second serial number does not have a match, the status may be that the certificate is either not monitored or not registered. For example, if the serial number does not exist within observability platform 402, the status may be that the certificate is registered but not monitored, and if the serial number does not exist within machine identity management platform 404, the status may be that the certificate is monitored but not registered. In such cases, step 812 may involve querying whether the certificate is expired or approaching expiry by accessing observability platform 402 or machine identity management platform 404. If the certificate is approaching expiry or already expired, step 812 may involve generating and transmitting a certificate renewal request to machine identity management platform 404. In some embodiments, step 812 may involve providing the status to a user interface. For example, correlational data 620 and/or the statuses described herein may be represented in a report that is presented in a display of a user interface.

An exemplary operating environment for implementing various aspects of this disclosure is illustrated in FIG. 9. As illustrated in FIG. 9, an exemplary operating environment 900 may include a computing device 902 (e.g., a general-purpose computing device) in the form of a computer. Components of the computing device 902 may include, but are not limited to, various hardware components, such as one or more processors 906, data storage 908, a system memory 904, other hardware 910, and a system bus (not shown) that couples (e.g., communicably couples, physically couples, and/or electrically couples) various system components such that the components may transmit data to and from one another.

With further reference to FIG. 9, an operating environment 900 for an exemplary embodiment includes at least one computing device 902. The computing device 902 may be a uniprocessor or multiprocessor computing device. An operating environment 900 may include one or more computing devices (e.g., multiple computing devices 902) in a given computer system, which may be clustered, part of a local area network (LAN), part of a wide area network (WAN), client-server networked, peer-to-peer networked within a cloud, or otherwise communicably linked. A computer system may include an individual machine or a group of cooperating machines. A given computing device 902 may be configured for end-users, e.g., with applications, for administrators, as a server, as a distributed processing node, as a special-purpose processing device, or otherwise configured to train machine learning models and/or use machine learning models.

One or more users may interact with the computer system comprising one or more computing devices 902 by using a display, keyboard, mouse, microphone, touchpad, camera, sensor (e.g., touch sensor) and other input/output devices 918, via typed text, touch, voice, movement, computer vision, gestures, and/or other forms of input/output. An input/output device 918 may be removable (e.g., a connectable mouse or keyboard) or may be an integral part of the computing device 902 (e.g., a touchscreen, a built-in microphone). A user interface 912 may support interaction between an embodiment and one or more users. A user interface 912 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad.

Computing device 902 includes at least one logical processor 906. The at least one logical processor 906 may include circuitry and transistors configured to execute instructions from memory (e.g., memory 904). For example, the at least one logical processor 906 may include one or more central processing units (CPUs), arithmetic logic units (ALUs), Floating Point Units (FPUs), and/or Graphics Processing Units (GPUs). The computing device 902, like other suitable devices, also includes one or more computer-readable storage media, which may include, but are not limited to, memory 904 and data storage 908. In some embodiments, memory 904 and data storage 908 may be part a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 920 such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 902, making its content accessible for interaction with and use by processor(s) 906. The removable configured medium 920 is an example of a computer-readable storage medium. Some other examples of computer-readable storage media include built-in random access memory (RAM), read-only memory (ROM), hard disks, and other memory storage devices which are not readily removable by users (e.g., memory 904). In some embodiments, configured medium 920 may be non-transitory.

The configured medium 920 may be configured with instructions (e.g., binary instructions) that are executable by a processor 906; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 920 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 910 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In some embodiments, the system includes multiple computing devices 902 connected by network(s) 916. Networking interface equipment can provide access to network(s) 916, using components (which may be part of a network interface 914) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The computing device 902 may operate in a networked or cloud-computing environment using logical connections to one or more remote devices (e.g., using network(s) 916), such as a remote computer (e.g., another computing device 902). The remote computer may include one or more of a personal computer, a server, a router, a network PC, or a peer device or other common network node, and may include any or all of the elements described above relative to the computer. The logical connections may include one or more LANs, WANs, and/or the Internet.

Computing device 902 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer.

The data storage 908 or system memory includes computer storage media in the form of volatile and/or nonvolatile memory such as ROM and RAM. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 908 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Computer-readable media may be embodied as a computer program product, such as software (e.g., including program modules) stored on non-transitory computer-readable storage media. Any combination of one or more computer-readable medium(s) may be utilized. The computer-readable medium may be a non-transitory computer-readable storage medium.

It will be apparent to those skilled in the art that various modifications and variations can be made to the environment instantiation platform. While illustrative embodiments have been described herein, the scope of the invention includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit of the invention being indicated by the following claims and their full scope of equivalents.

1. A method performed by at least one processor for correlating Secure Sockets Layer (SSL) certificate data, the method comprising:
accessing, with an observability platform, SSL data;
extracting, from the SSL data, first certificate data for a certificate, the first certificate data including a first serial number, host name, and expiration date;
obtaining second certificate data for the certificate from a machine identity management platform, the second certificate data including a second serial number and a common name;
normalizing the first serial number and the second serial number to a standard format;
generating correlational data by correlating the normalized first serial number with the normalized second serial number, wherein the correlational data includes the host name, the common name, and the expiration date; and
determining a status of the certificate based on the correlational data.

2. The method of claim 1, wherein the SSL data establishes a secure connection over an SSL port.

3. The method of claim 1, wherein determining the status of the certificate includes determining if the certificate is expired or redundant.

4. The method of claim 3, further comprising:
based on a determination that the certificate is expired, generating and transmitting a certificate renewal request to the machine identity management platform.

5. The method of claim 1, further comprising displaying the status on a user interface.

6. The method of claim 1, wherein correlating the normalized first and second serial numbers includes performing one or more relational operations.

7. The method of claim 1, further comprising accessing the observability platform via a first application programming interface (API) and accessing the machine identity management platform via a second API.

8. A system comprising:
a memory storing instructions;
a database, in electronic communication with the memory, configured to store information comprising:
a processor, in electronic communication with the database, configured to execute the instructions to perform operations comprising:
accessing, with an observability platform, SSL data;
extracting, from the SSL data, first certificate data for a certificate, the first certificate data including a first serial number, host name, and expiration date;
obtaining second certificate data for the certificate from a machine identity management platform, the second certificate data including a second serial number and a common name;
normalizing the first serial number and the second serial number to a standard format;
generating correlational data by correlating the normalized first serial number with the normalized second serial number, wherein the correlational data includes the host name, the common name, and the expiration date; and
determining a status of the certificate based on the correlational data.

9. The system of claim 8, wherein the SSL data establishes a secure connection over an SSL port.

10. The system of claim 8, wherein determining the status of the certificate includes determining if the certificate is expired or redundant.

11. The system of claim 10, wherein the operations further comprise:
based on a determination that the certificate is expired, generating and transmitting a certificate renewal request to the machine identity management platform.

12. The system of claim 8, wherein the operations further comprise displaying the status on a user interface.

13. The system of claim 8, wherein correlating the normalized first and second serial numbers includes performing one or more relational operations.

14. The system of claim 8, wherein the operations further comprise accessing the observability platform via a first application programming interface (API) and accessing the machine identity platform via a second API.

15. A non-transitory computer-readable medium including instructions that are executable by one or more processors to perform operations comprising:
accessing, with an observability platform, SSL data;
extracting, from the SSL data, first certificate data for a certificate, the first certificate data including a first serial number, host name, and expiration date;
obtaining second certificate data for the certificate from a machine identity management platform, the second certificate data including a second serial number and a common name;
normalizing the first serial number and the second serial number to a standard format;
generating correlational data by correlating the normalized first serial number with the normalized second serial number, wherein the correlational data includes the host name, the common name, and the expiration date; and
determining a status of the certificate based on the correlational data.

16. The non-transitory computer-readable medium of claim 15, wherein the operations further comprise accessing the observability platform via a first application programming interface (API) and accessing the machine identity management platform via a second API.

17. The non-transitory computer-readable medium of claim 15, wherein determining the status of the certificate includes determining if the certificate is expired or redundant.

18. The non-transitory computer-readable medium of claim 17, wherein the operations further comprise:
based on a determination that the certificate is expired, generating and transmitting a certificate renewal request to the machine identity management platform.

19. The non-transitory computer-readable medium of claim 15, wherein the operations further comprise displaying the status on a user interface.

20. The non-transitory computer-readable medium of claim 15, wherein correlating the normalized first and second serial numbers includes performing one or more relational operations.
